(19) United States
(12) Patent Application Publication
(10) Pub. No.: US 2024/0016098 A1
(43) Pub. Date: Jan. 18, 2024

(54) WORKING TOOL WITH ARTICULATING HEAD

(71) Applicant: Milwaukee Electric Tool Corporation, Brookfield, WI (US)

(72) Inventors: Sara Manulik, Brookfield, WI (US); Sean Conaway, Brookfield, WI (US)

(21) Appl. No.: 18/219,810

(22) Filed: Jul. 10, 2023

Related U.S. Application Data
(60) Provisional application No. 63/388,286, filed on Jul. 12, 2022.

(51) Int. Cl. A01G 3/047

(52) U.S. Cl. CPC A01G 3/047

(57) ABSTRACT

A working tool with an articulation mechanism between a tool head and a tool shaft is provided. The working tool includes a tool head and an elongate shaft. The tool head is configured to articulate relative to the elongate shaft. The elongate shaft includes an articulating head connection having a pin. The tool head includes an articulating head attachment configured to couple with the articulating head connection and has at least two receiving openings for receiving the pin. The working tool further includes a shaft for rotation extending through the articulating head connection and the articulating head attachment. The shaft forms an axis of rotation for the tool head.

### CROSS-REFERENCE TO RELATED APPLICATIONS

The present application claims priority to U.S. Provisional Patent Application No. 63/388,286 filed on Jul. 12, 2022, the disclosure of which is incorporated by reference herein in its entirety.

### FIELD

The present disclosure relates generally to a handheld working tool with an articulating head relative to a shaft of the working tool.

### BACKGROUND

Various handheld working tools may be connected to an elongate pole or shaft, e.g., to extend the reach of the working tool. The elongate pole or shaft may have a telescoping function to extend the reach of the tool head of the working tool to a desired length. However, based on the reach of the working tool and the position of a user, it can be desirable or necessary to position the head of the working tool at an angle relative to the elongate pole or shaft. Moreover, it can be desirable to choose an angle for the working tool among multiple options. Thus, a working tool head that is configured to articulate or rotate to several different positions or angles relative to the elongate pole or shaft may be advantageous.

Accordingly, improved working tools and articulation mechanisms for working tools are desired in the art.

### BRIEF DESCRIPTION

Aspects and advantages of the invention in accordance with the present disclosure will be set forth in part in the following description, or may be obvious from the description, or may be learned through practice of the technology.

In accordance with one embodiment, a working tool with an articulation mechanism between a tool head and a tool shaft is provided. The working tool includes a tool head and an elongate shaft. The tool head is configured to articulate relative to the elongate shaft. The elongate shaft includes an articulating head connection having a pin. The tool head includes an articulating head attachment configured to couple with the articulating head connection and has at least two receiving openings for receiving the pin. The working tool further includes a shaft for rotation extending through the articulating head connection and the articulating head attachment. The shaft forms an axis of rotation for the tool head.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of a working tool in accordance with embodiments of the present disclosure;

FIG. 2 is a front cross-sectional view of a working tool in accordance with embodiments of the present disclosure;

FIG. 3 is a perspective cross-sectional view of a working tool in accordance with embodiments of the present disclosure;

FIG. 4 is a side view of a working tool in accordance with embodiments of the present disclosure;

FIG. 5 is a front cross-sectional view of a working tool in accordance with embodiments of the present disclosure;

FIG. 6 is a front cross-sectional view of a working tool in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having,” or any other variation thereof, are intended to cover a non-exclusive inclusion. For exam*, a process, method, article, or apparatus that comprises a list of features is not necessarily limited only to those features hut may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

As used herein, “articulating joint” is used to mean a structure in which relative motion is allowed to occur between parts, usually by means of a hinged joint. “Articulation” is used herein to describe the relative motion between parts connected by an articulating joint.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, a working tool includes a tool head and an elongate shaft. The tool head is configured to articulate to one of a plurality of angles of articulation relative to the elongate shaft. An articulation mechanism may be operated manually or may be motorized.

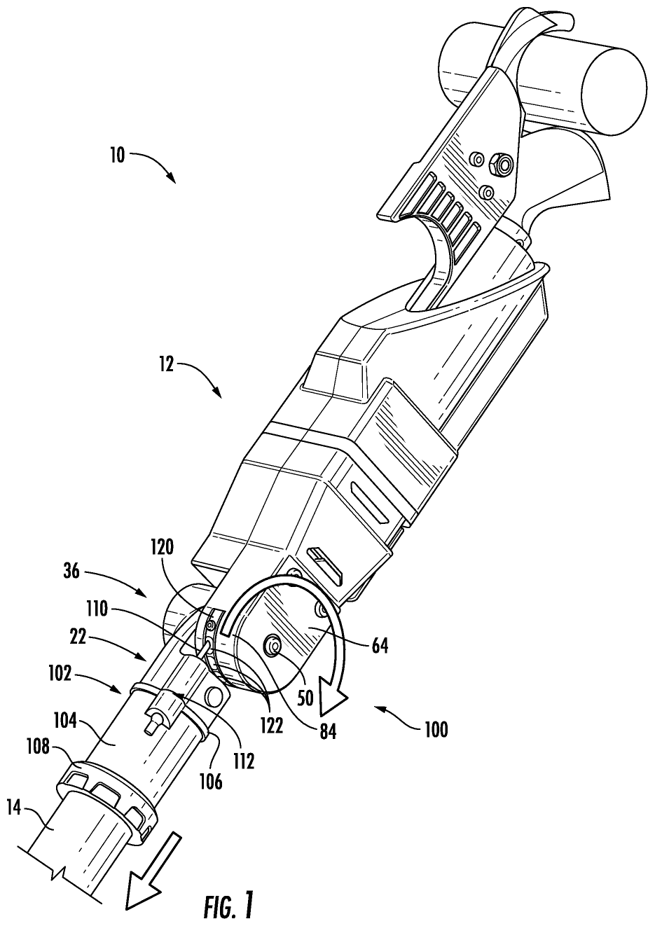

Referring now to the drawings, FIG. 1 illustrates an exemplary working tool 10 of the present invention. For instance, the working tool 10 of FIG. 1 may be a pruning shear, e.g., a telescoping pruning shear. The working tool 10 has an elongate shaft 14 coupled to a tool head 12. The tool head 12 has a functional tool 13 at a proximal end thereof, e.g., a pruning shear, and an articulating head attachment 60 at a distal end thereof. The articulating head attachment 60 is configured to be coupled to an articulating head attachment 18 disposed at the proximal end 16 of the elongate shaft 14. In this manner, an articulating joint is formed between the elongate shaft 14 and the tool head 12.

The articulating head connection 18 of the elongate shaft 14 includes a housing 20 coupled to the proximal end 16 of the elongate shaft 14. The housing 20 includes a cylindrical section 22 at a distal end of the housing 20 that is configured to be coupled to the proximal end 16 of the elongate shaft 14. For instance, a cylindrical wall 24 of the cylindrical section 22 can be configured to surround the proximal end 16 of the elongate shaft 14. The distal end of the cylindrical section 22 can include an opening formed by the cylindrical wall 26 for receiving the elongate shaft 14. At a proximal end of the cylindrical section 22, the cylindrical section 22 may have a stop surface 28 extending in a radial direction from a portion of the cylindrical wall 26 relative to the elongate shaft 14 that is configured to hold the proximal end 16 of the elongate shaft 14 in place. The stop surface 28 can extend a width from the cylindrical wall to a central longitudinal axis of the cylindrical section 22.

Opposite the stop surface 28 in a radial direction, an extension section 30 of the housing 20 can be formed in a perpendicular direction relative to the stop surface 28. For instance, the extension section 30 can be formed by an extension of the cylindrical wall 26, e.g., a semi-cylindrical wall 32, and an opposite wall 34 extending generally perpendicular from the stop surface 28. The opposite wall 34 can be a planar wall, e.g., flat and/or straight, or have any curvature or bends as desirable to receive the articulating head attachment 60, as will be described in further detail below.

Proximal to the extension section 30 of the housing 20 of the articulating head connection 18, a receiving section 36 is formed. The receiving section 36 may include a receiving opening 38 formed between the opposite wall 34 of the extension section 30 and an upper radial wall 40 extending in a radial direction of the elongate shaft 14, e.g., perpendicular to the opposite wall 34. The housing 20 further includes a receiving section sidewall 42 extending from the semi-cylindrical wall 32 of the extension section 30 to the upper radial wall 40. In some aspects of the present invention, the receiving section sidewall 42 may protrude from the semi-cylindrical wall 32 in a radial direction.

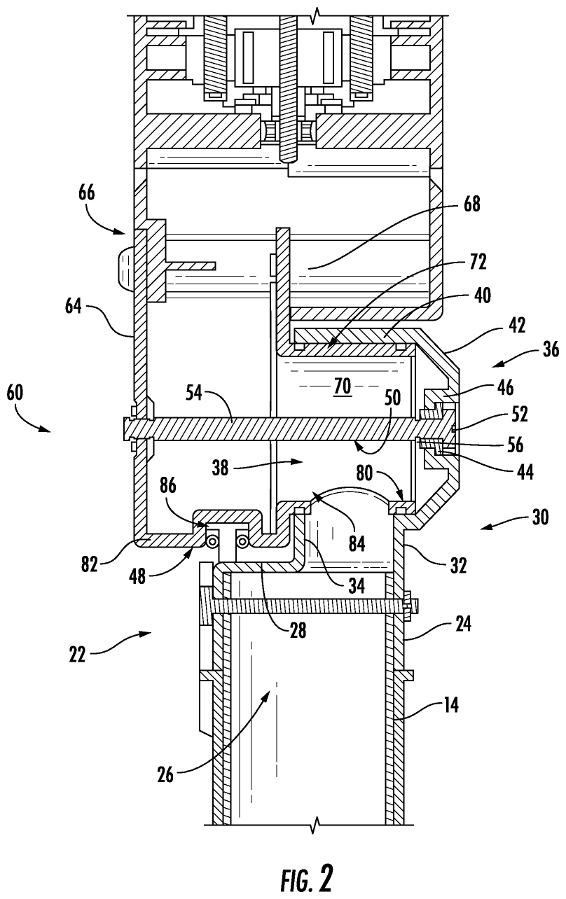

As illustrated in FIG. 2, the receiving section 36 may receive a shaft for rotation 50 extending therethrough. The shaft for rotation 50 may form an axis about which the tool head 12 is configured to articulate or rotate with respect to the elongate shaft 14. The shaft for rotation 50 may include a head 52 and an elongate body 54. The receiving section sidewall 42 may include an aperture 44 through which the elongate body 54 of the shaft for rotation 50 can be inserted. The receiving section sidewall 42 may further include a shaft head stop surface 46 configured to contact the shaft head 52 to prevent insertion of the shaft head 52 through the aperture 44. A gasket 56, such as an O-ring, may be provided between the shaft head 52 and the aperture 44 and/or stop surface 46. For instance, as illustrated in FIG. 2, the gasket 56 is configured to surround the elongate body 54 adjacent to the shaft head 52 and contact both the aperture 44 and the stop surface 46 of the receiving section sidewall 42. The elongate body 54 of the shaft for rotation 50 may extend through the receiving opening 38 and out into a receiving space 48 formed between the receiving opening 38, the opposite wall 34 of the extension section 30 of the articulating head connection 18, and the stop surface 28 of the cylindrical section 22 of the articulating head connection 18, wherein the receiving space 48 is sized and shaped to receive at least a portion of the articulating head attachment 60 of the tool head 12.

As shown in FIGS. 1-2, the tool head 12 includes an articulating head attachment 60 that is configured to couple to the articulating head connection 18 of the elongate shaft 14. The articulating head attachment 60 includes a housing 62. The housing 62 of the articulating head attachment 60 can be integrated with the tool head 12, e.g., formed in one piece with a housing of the tool head 12, or may be formed separately and coupled to the tool head 12, as shown in FIG. 2.

The housing 62 of the articulating head attachment 60 includes a first sidewall 64 extending a longitudinal length of the housing 62 from a proximal end to a distal end. The first sidewall 64 can include an opening 66 for receiving a coupling element to couple the housing 62 to the tool head 12 if necessary or desired. The housing 62 includes a second sidewall 68 extending from the proximal end of the housing 62 opposite the first sidewall 64. An insertion section 70 extends from the second sidewall 68 in a radial direction, i.e., generally perpendicular to the second sidewall 68. The insertion section 70 includes an insertion section sidewall 72 extending from the second sidewall 68 in a radial direction, i.e., generally perpendicular to the second sidewall 68. An end opening 74 is formed through the insertion section sidewall 72 and configured to receive the shaft for rotation 50 therethrough. The insertion section sidewall 72 may also include one or more sidewall openings 76 through the insertion section sidewall 72. The insertion section sidewall 72 is configured to be inserted through the receiving opening 38 and into the receiving section 36 of the articulating head connection 18. An outer surface of the insertion section sidewall 72 includes one or more channels 78 configured to receive an O-ring 80 therein. Each O-ring is configured to provide a frictional engagement between the outer surface of the insertion section sidewall 72 and an inner surface of the receiving section 36 of the articulating head connection 18. Additionally, the insertion section sidewall 72 may include one or more connection elements 82 configured to engage with a corresponding surface of the receiving section 36 or extension section 30 of the articulating head connection 18. For instance, the connection elements 82 may be provided on either side of a sidewall opening 76. A first connection element 82 may be configured to engage with the semi-cylindrical wall 32 and a second connection element 82 may be configured to engage with the opposite wall 34 of the extension section 30 of the articulating head connection 18. For instance, each connection element 82 may have a stop surface extending in a direction perpendicular to the insertion section sidewall 72 configured to engage with the articulating head connection 18.

The housing 62 of the articulating head attachment 60 further includes an endwall 84 extending from the first sidewall 64 to a distal end of the insertion section 70. The endwall 84 may be formed from an arcuate surface. The endwall 84 may include a receiving channel 86 for receiving at least a portion of an articulation mechanism, to be described in further detail below.

As illustrated in FIG. 2, the articulating head attachment 60 is configured to receive the shaft for rotation 50 through the end opening 74 of the insertion section 70. The shaft for rotation 50 can extend through an aperture 90 in the first sidewall 64. When the insertion section 70 is inserted into the receiving section 36 as shown in FIG. 2, the aperture 44 in the receiving section sidewall 42 is configured to be aligned with the aperture 90 in the first sidewall 64 of the housing 62 such that the shaft for rotation 50 extends generally perpendicular relative to a longitudinal direction of the elongate shaft 14. One or more fixing elements 92, e.g., nuts or bolts, may be provided to secure the shaft for rotation 50 within the aperture 90. In this arrangement, the articulating head connection 18 and the articulating head attachment are coupled together via the shaft for rotation 50, and the articulating head attachment 60 can articulate or rotate about an axis formed by the shaft for rotation 50 relative to the longitudinal axis of the elongate shaft 14.

In order to secure the articulating head attachment 60 at a desired angle relative to the longitudinal axis of the elongate shaft 14, an articulation mechanism 100 is provided. In some aspects of the present invention, the articulation mechanism 100 can be manually operated by a user of the tool 10.

FIGS. 1-2 illustrate a manual articulation mechanism 100. A latch 102 can be coupled to the elongate shaft 14. For example, the latch 102 can include a cylindrical body 104 configured to receive the elongate shaft 14 therethrough. The cylindrical body 104 can have a proximal end 106 configured to abut a distal end of the cylindrical section 22 of the housing 20 of the articulating head connection 18. The latch 102 can have a protruding section 108 at a distal end thereof. The protruding section 108 can form a gripping surface for a user to grip to slide the latch in a distal direction along the length of the elongate shaft 14. The latch 102 further includes a pin 110 received in a pin channel 112. The pin 110 is configured to extend through the pin channel 112, which may be formed in or on the cylindrical body 104 of the latch 102, the cylindrical section 22 of the housing 20 of the articulating head connection 18, or both, as shown in FIG. 1. The pin channel 112 is configured to be offset from the shaft for rotation 50 in both a radial direction and an axial direction. In other words, the pin channel 112 is disposed at a radially outward portion of the cylindrical body 104 and cylindrical section 22 away from a central longitudinal axis of the elongate shaft 14, and the pin 110 is further separated from the shaft for rotation 50 in a longitudinal or axial direction. A proximal end 114 of the pin 110 is configured to extend from the pin channel 112 into the receiving space 48. One or more stop elements 116, e.g., nuts or bolts, may be provided to the pin 110 to hold the pin 110 in place with respect to the pin channel 112. The latch 102 may further be provided with a coil spring (not shown) configured to bias the latch 102 in a locked arrangement, e.g., toward the proximal end 16 of the elongate shaft 14 and toward the articulating head connection 18 and the articulating head attachment 60.

Still referring to FIGS. 1-2, the articulating head attachment 60 may include a pin receiver 120 configured to receive the proximal end 114 of the pin 110 therein. The pin receiver 120 can be received in the receiving channel 88 on the endwall 84 and includes two or more receiving openings 122 spaced apart along a length of the pin receiver 120. Each receiving opening 122 is sized and shaped to receive the proximal end 114 of the pin 110 and retain the pin 110 in place.

Each receiving opening 122 may correspond to an angle of articulation between the elongate shaft 14 and the tool head 12. For instance, a first receiving opening 122 may correspond to a 0° angle between the elongate shaft 14 and the tool head 12, i.e., the tool head 12 extends in longitudinal alignment with a longitudinal axis of the elongate shaft 14. Each additional receiving opening 122 can correspond to a non-zero degree angle between the tool head 12 and the elongate shaft 14.

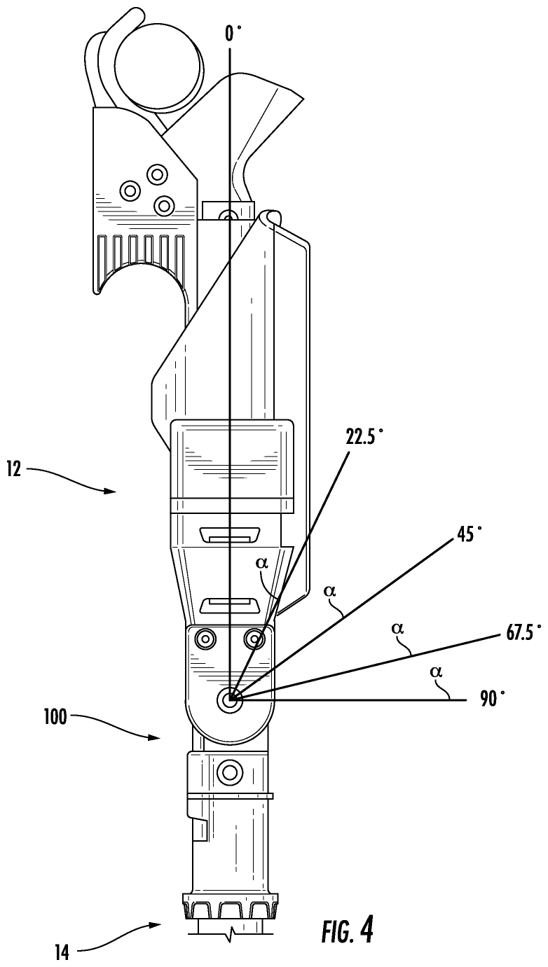

For instance, the tool head 12 may be configured to articulate to a relative angular position in a range from about −150° to about 150° with respect to a longitudinal axis of the elongate shaft 14 at any desired interval therebetween. For instance, receiving openings 122 may be provided in the pin receiver 120 to correspond to articulation intervals a of from about 5° to about 150°, such as articulation intervals a of about 10°, 15°, 20°, 22.5°, 30°, 45°, 60°, 90°, 120°, or any other desired articulation interval. The receiving openings 122 may be equally spaced apart such that the articulation intervals a are equal (i.e., equal angles); or the receiving openings 122 may be spaced apart by non-equal intervals. In the embodiment illustrated in FIGS. 1-2, the pin receiver 120 includes five pin receiving openings 122 spaced apart along the length of the endwall 84 to achieve articulation intervals a of about 22.5° in an articulation range from about 0° to about 90°, as best illustrated in FIG. 4.

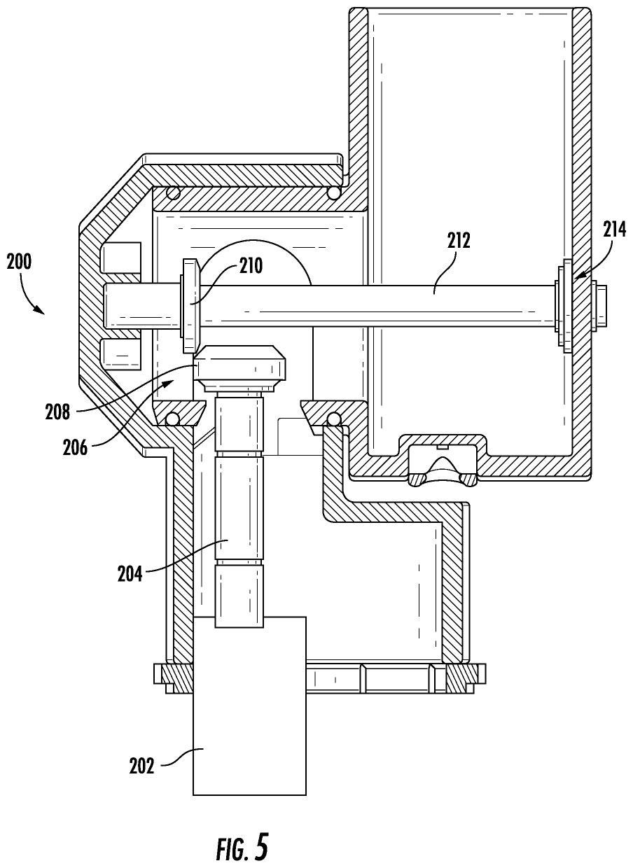

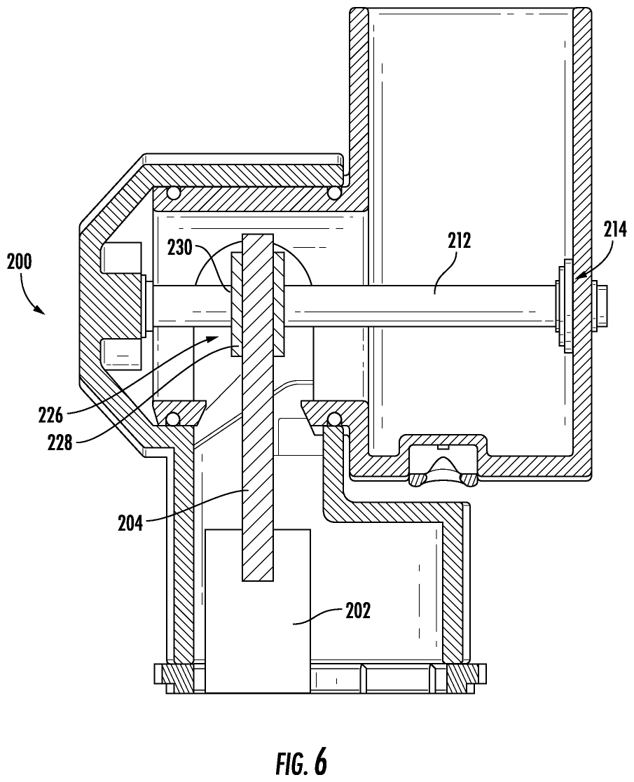

In another aspect of the present invention as illustrated in FIGS. 5-6, there may be a motorized articulation mechanism 200 having a motor 202 configured to drive the articulation of the tool head 12 relative to the elongate shaft 14. The motor 202 is coupled to a motor shaft 204 configured to rotate when the motor 202 is operated. The motor 202 can be a cam motor, a stepper motor, a brushless motor, and/or any suitable motor configuration. The motorized articulation mechanism 200 is provided with a rotation shaft 212 that corresponds to the shaft for rotation 50 of the manual embodiment described above, such that the rotation shaft 212 defines an axis of rotation for the tool head. The rotation shaft 212 includes a keyed interface that is configured to interface with the first sidewall 64 to transmit rotation driven by the motor 202 to the tool head 12. One or more stops may be provided to the rotation shaft 212 to define the articulation angles α. The one or more stops can be in the form of a physical stop feature on the rotation shaft 212 or a gear system (as described below) and/or one or more Hall sensors provided to sense the amount of rotation of the rotation shaft 212 and control the motor 202 to initiate and/or cease driving rotation of the rotation shaft 212 to achieve a desired articulation angle α.

In one configuration of the motorized articulation mechanism 200 shown in FIG. 5, at an opposite end of the motor shaft 204 from the motor 202, a bevel gear set 206 may be provided to couple a bevel gear pinion 208 of the motor shaft 204 to a bevel gear 210 coupled to the rotation shaft 212. The bevel gear 210 can be press fit onto an end of the rotation shaft 212 or coupled in any other suitable manner to the rotation shaft 212.

In another aspect of the motorized articulation mechanism 200 shown in FIG. 6, the motor shaft 204 can be provided with a worm gear system 226. A worm gear 228 may be provided on the motor shaft 204. The worm gear 228 can be machined with the motor shaft 204 or press fit onto the motor shaft 204. The rotation shaft 212 can include a cooperating gear 230 configured to cooperate with the worm gear 228. The cooperating gear 230 can be press fit onto the rotation shaft 212 or coupled in any other suitable manner to the rotation shaft 212.

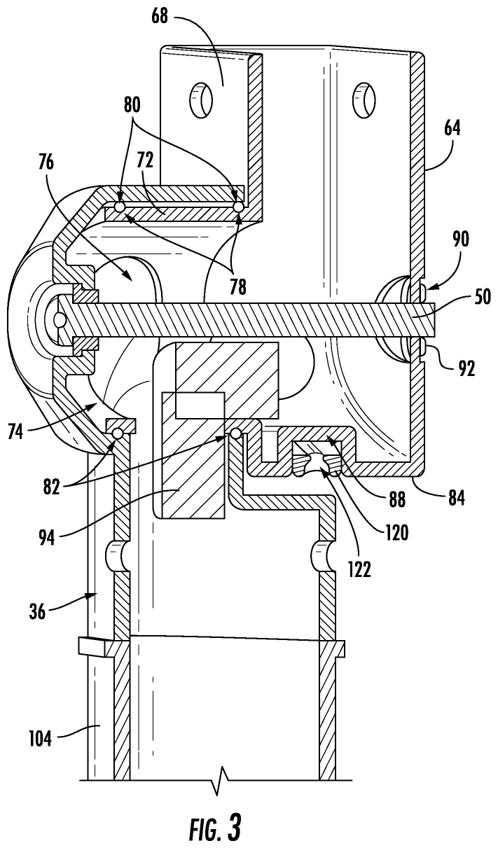

Turning back to FIG. 3, the housing 20 of the articulating head connection 18 and the housing 62 of the articulating head attachment 60 may both be formed from a hollow construction to enable one or more elements to pass continuously through the elongate shaft 14, the housing 20 of the articulating head connection 18, the housing 62 of the articulating head attachment 60 and into the tool head 12. For instance, one or more wires or cables may extend through the elongate shaft 14, the housing 20 of the articulating head connection 18, the housing 62 of the articulating head attachment 60 and into the tool head 12. In one aspect of the present invention, as illustrated in FIG. 3, a wire 94 having a 13 mm diameter may extend continuously through the elongate shaft 14, the housing 20 of the articulating head connection 18, the housing 62 of the articulating head attachment 60 and into the tool head 12 without impacting articulation of the tool head 12 relative to the elongate shaft 14. In this arrangement, one or more elements of the tool head 12 can be powered or driven, e.g., via cable(s) or wire(s) extending from a source distal from the tool head 12, e.g., coupled to or within the elongate shaft 14.

Further aspects of the invention are provided by one or more of the following embodiments:

A working tool includes a tool head and an elongate shaft. The tool head is configured to articulate relative to the elongate shaft. The elongate shaft includes an articulating head connection having a pin. The tool head includes an articulating head attachment configured to couple with the articulating head connection and has at least two receiving openings for receiving the pin. The working tool further includes a shaft for rotation extending through the articulating head connection and the articulating head attachment. The shaft forms an axis of rotation for the tool head.

The working tool of any one or more of the embodiments, wherein the tool head is configured to articulate relative to the elongate shaft at an angle in a range from about −150° to about 150° from a longitudinal axis of the elongate shaft.

The working tool of any one or more of the embodiments, wherein the tool head is configured to articulate relative to the elongate shaft between a plurality of positions spaced apart by an angle in a range from about 10 degrees to about 90 degrees.

The working tool of any one or more of the embodiments, wherein the at least two receiving openings comprises from two to fifteen receiving openings.

The working tool of any one or more of the embodiments, wherein each receiving opening corresponds to a relative angular position between the tool head and the elongate shaft.

The working tool of any one or more of the embodiments, wherein each of the openings are equally spaced apart such that each relative angular position between the tool head and the elongate shaft is spaced apart by an equal angle.

The working tool of any one or more of the embodiments, wherein the articulating head connection further comprises a latch, wherein the latch is coupled to the pin, wherein in a locked position of the latch, the pin is received in one of the receiving openings of the articulating head connection, and in an unlocked position of the latch, the pin is displaced from each of the receiving openings such that the tool head is permitted to rotate about the shaft for rotation.

The working tool of any one or more of the embodiments, wherein the latch comprises a latch body surrounding the elongate shaft, a channel formed in the latch body for receiving the pin, and a coil spring configured to bias the latch toward the locked position of the latch.

The working tool of any one or more of the embodiments, wherein the articulating head connection comprises a housing, wherein the shaft for rotation extends through the housing of the articulating head connection, and a receiving opening surrounding the shaft for rotation. The articulating head attachment comprises a housing, wherein the shaft for rotation extends through the housing of the articulating head attachment. At least a portion of the housing of the articulating head attachment is positioned within the receiving opening of the housing of the articulating head connection.

The working tool of any one or more of the embodiments, further comprising a motorized articulation mechanism configured to drive articulation of the tool head relative to the elongate shaft, wherein the motorized articulation mechanism comprises a motor, a motor shaft, and a gear system configured to couple the motor shaft to the shaft for rotation.

The working tool of any one or more of the embodiments, wherein the gear system comprises a bevel gear system or a worm gear system.

The working tool of any one or more of the embodiments, further comprising at least one stop configured to define articulation intervals of rotation of the tool head relative to the elongate shaft.

The working tool of any one or more of the embodiments, wherein the at least one stop comprises a physical stop surface and/or at least one hall sensor to sense rotation of the shaft for rotation.

The working tool of any one or more of the embodiments, further comprising a cable or wire extending continuously through the elongate shaft, the articulating head connection, the articulating head attachment, and into the tool head.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A working tool comprising:
a tool head, and
an elongate shaft, the tool head being configured to articulate relative to the elongate shaft,
the elongate shaft comprising an articulating head connection comprising a pin,
the tool head comprising an articulating head attachment configured to couple with the articulating head connection and having at least two receiving openings for receiving the pin,
the tool head further comprising a shaft for rotation extending through the articulating head connection and the articulating head attachment, wherein the shaft forms an axis of rotation for the tool head.

2. The working tool of claim 1, wherein the tool head is configured to articulate relative to the elongate shaft at an angle in a range from about −150° to about 150° from a longitudinal axis of the elongate shaft.

3. The working tool of claim 1, wherein the tool head is configured to articulate relative to the elongate shaft between a plurality of positions spaced apart by an angle in a range from about 10 degrees to about 90 degrees.

4. The working tool of claim 1, wherein the at least two receiving openings comprises from two to fifteen receiving openings.

5. The working tool of claim 4, wherein each receiving opening corresponds to a relative angular position between the tool head and the elongate shaft.

6. The working tool of claim 5, wherein each of the openings are equally spaced apart such that each relative angular position between the tool head and the elongate shaft is spaced apart by an equal angle.

7. The working tool of claim 1, the articulating head connection further comprising a latch coupled to the pin,
wherein in a locked position of the latch, the pin is received in one of the receiving openings of the articulating head connection, and in an unlocked position of the latch, the pin is displaced from each of the receiving openings such that the tool head is permitted to rotate about the shaft for rotation.

8. The working tool of claim 7, wherein the latch comprises a latch body surrounding the elongate shaft, a channel formed in the latch body for receiving the pin, and a coil spring configured to bias the latch toward the locked position of the latch.

9. The working tool of claim 1, the articulating head connection comprising a housing,
wherein the shaft for rotation extends through the housing of the articulating head connection, and a receiving opening surrounds the shaft for rotation,
further wherein the articulating head attachment comprises a housing, wherein the shaft for rotation extends through the housing of the articulating head attachment,
wherein at least a portion of the housing of the articulating head attachment is positioned within the receiving opening of the housing of the articulating head connection.

10. The working tool of claim 1, further comprising a motorized articulation mechanism configured to drive articulation of the tool head relative to the elongate shaft, wherein the motorized articulation mechanism comprises a motor, a motor shaft, and a gear system configured to couple the motor shaft to the shaft for rotation.

11. The working tool of claim 10, wherein the gear system comprises a bevel gear system or a worm gear system.

12. The working tool of claim 10, further comprising at least one stop configured to define articulation intervals of rotation of the tool head relative to the elongate shaft.

13. The working tool of claim 12, wherein the at least one stop comprises a physical stop surface and/or at least one hall sensor to sense rotation of the shaft for rotation.

14. The working tool of claim 1, further comprising a cable or wire extending continuously through the elongate shaft, the articulating head connection, the articulating head attachment, and into the tool head.
